(19) United States
(12) Patent Application Publication
(10) Pub. No.: US 2026/0264996 A1
(43) Pub. Date: Sep. 10, 2026

(54) CONVEYOR MODULE WITH IMPROVED PRODUCT RELEASE AND CONVEYOR BELTS AND CONVEYOR CHAINS HAVING SAME

(71) Applicant: Habasit Italiana S.p.A., CESANO BOSCONE (MI) (IT)

(72) Inventors: Caleb SOUTHWICK, Leesport, PA (US); Dietmar ELSNER, Reinach (CH)

(21) Appl. No.: 19/075,732

(22) Filed: Mar. 10, 2025

(51) Int. Cl. B65G 17/08

(52) U.S. Cl. CPC B65G 17/08; B65G 2207/30

(57) ABSTRACT

The present disclosure provides a module for a modular conveyor belt or conveyor chain. The module includes a first set of link ends extending in a first direction along a direction of travel. A second set of link ends extends in a second direction opposite the first direction. Each link end of the first set of link ends and the second set of link ends has a transverse opening. The first and second link ends being offset such that the first set of link ends are configured to interdigitate with the second set of link ends of an adjacent module to provide aligned transverse openings for connecting adjacent modules with pivot rods. The module includes a plurality of ribs. A top edge of each of the ribs has a waveform profile, and a conveying surface is formed by the top edges of the plurality of ribs.

### FIELD OF THE DISCLOSURE

The present disclosure relates to conveyor systems, and more specifically to modules for conveyor belts and conveyor chains designed to reduce adhesion in, for example, industrial food production processes.

### BACKGROUND OF THE DISCLOSURE

Conveyor belts and conveyor chains are essential in food manufacturing for transporting ingredients and products through production stages. A significant challenge in this industry is the adhesion of food materials—particularly those with high moisture, fat, or sugar content—to conveyor belt surfaces. This adhesion creates multiple problems, including operational inefficiencies and increased downtime due to cleaning requirements; product loss affecting overall yield; potential contamination risks from accumulated residue; and microbial growth concerns in adhered materials.

Conventional conveyor belts made from materials such as PVC and polyurethane offer durability but typically lack specialized anti-adhesion properties. Some product designs utilize release agents, but these can degrade under the harsh conditions of food production environments, including exposure to water, oils, and cleaning chemicals. The use of non-stick materials, such as PTFE, is impractical due to low strength and/or high cost of such materials.

There is a long-felt need in the food industry for a modular conveyor system that consistently reduces material adhesion across different food types while maintaining durability and food safety compliance.

### BRIEF SUMMARY OF THE DISCLOSURE

Embodiments of the present disclosure utilize a waveform profile of a top surface of ribs to promote product release and, in some embodiments, to be compatible with finger transfer plates. The undulating surface reduces contact area between the product and the conveyor surface which limits sticking, while also maintaining many discrete points of contact to provide near continuous support of the product.

An example application for a belt of the presently disclosed design is for cooking strips of bacon in microwave ovens. The raised rib surface is advantageous for smoothly transferring bacon strips off the conveyor at the exit of the microwave oven via finger comb plates. The waveform profile of the conveying surface promotes product release making transfer easier and more reliable.

Raised rib belts are commonly used in this application. Prior art belts have raised ribs with flat surfaces at the top of each rib on which a product is supported. However, such designs have a large contact area between the belt and the product which increases the likelihood of the product sticking to the belt. This contact area could be reduced by the use of fewer ribs (i.e., greater spacing between ribs), however this would reduce the number of support points for product. This may cause the product to deform, which is undesirable. For example, in applications where bacon is conveyed, the resulting bacon strips may be wavy as a result of large spacing between supporting ribs, which is undesirable.

The waveform profile of the conveying surface of the present disclosure reduces the contact area with the transported product while also maintaining sufficient support over a length of the product. This results from the many discrete points of contact with the product. Therefore, the waveform profile of the conveying surface helps promote easy product release. Using the example of bacon strips, the strips are sufficiently supported such that there is no undesirable waviness, while improving the ability to remove the bacon strips from the belt due to the waveform profile of the module conveying surface. The open form of some embodiments also promotes airflow, which helps to reduce heating of the belt (or chain) material.

### DESCRIPTION OF THE DRAWINGS

For a fuller understanding of the nature and objects of the disclosure, reference should be made to the following detailed description taken in conjunction with the accompanying drawings.

FIG. 1A: A side elevation view of a module according to an embodiment of the present disclosure.

FIG. 1B: A front elevation view of the module of FIG. 1A.

FIG. 1C: A top view of the module of FIGS. 1A-1B.

FIG. 1D: A perspective view of the module of FIGS. 1A-1C.

FIG. 2: A top view of two modules according to the embodiment shown in Figured 1A-1D, wherein the modules are connected by a pivot rod.

FIG. 3A: A side elevation view of a module according to another embodiment of the present disclosure.

FIG. 3B: A front elevation view of the module of FIG. 3A.

FIG. 3C: A top view of the module of FIGS. 3A-3B.

FIG. 3D: A perspective view of the module of FIGS. 3A-3C.

FIG. 4: A top view of a portion of a conveyor belt having three modules according to the embodiment shown in FIGS. 3A-3D.

FIG. 5A: A side elevation view of a module according to another embodiment of the present disclosure.

FIG. 5B: A top view of the module of FIG. 5A.

FIG. 5C: A perspective view of the module of FIGS. 5A-5B.

FIG. 6A: A side elevation view of a module according to another embodiment of the present disclosure.

FIG. 6B: A front elevation view of the module of FIG. 6A.

FIG. 6C: A top view of the module of FIGS. 6A-6B.

FIG. 6D: A perspective view of the module of FIGS. 6A-6C.

FIG. 7A: A side elevation view of a module according to another embodiment of the present disclosure.

FIG. 7B: A top view of the module of FIG. 7A.

FIG. 7C: A perspective view of the module of FIGS. 7A-7B.

FIG. 8A: A side elevation view of a module according to another embodiment of the present disclosure.

FIG. 8B: A top view of the module of FIG. 8A.

FIG. 8C: A perspective view of the module of FIGS. 8A-8B.

FIG. 9: A perspective view showing a module intersecting with a comb for removal of material carried on the conveying surface of the module (and the conveyor belt itself).

### DETAILED DESCRIPTION OF THE DISCLOSURE

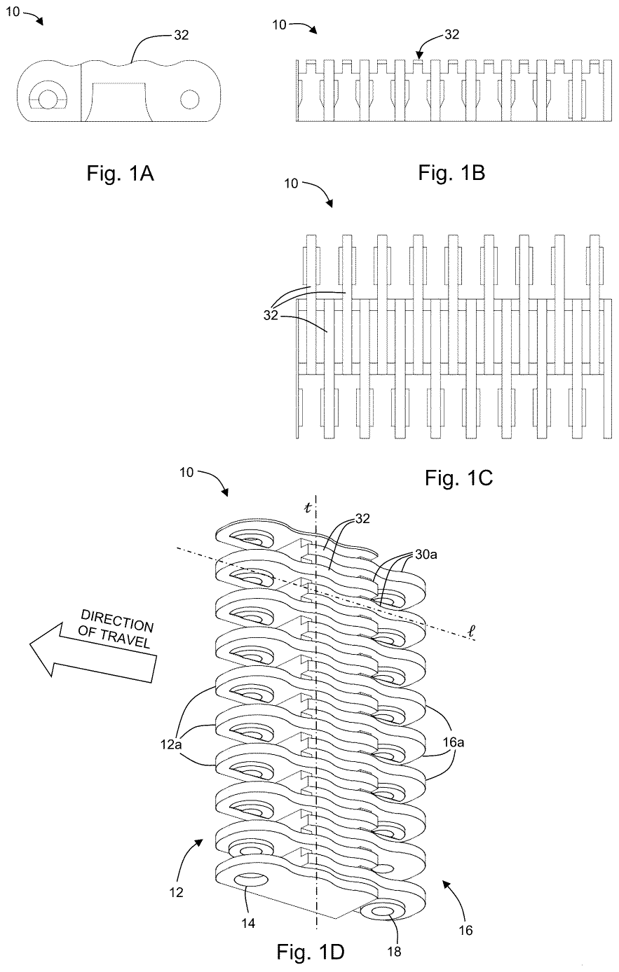

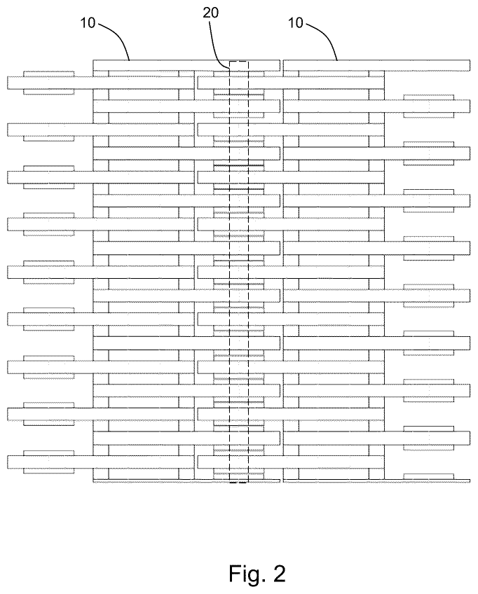

With reference to FIGS. 1A-1D and 2, in a first aspect, the present disclosure may be embodied as a module 10 for a modular conveyor belt or chain conveyor. The module 10 has a first set of link ends 12 extending in a first direction along a direction of travel. Each link end 12a of the first set of link ends has a first transverse opening 14. A second set of link ends 16 extends from the module in a second direction, which is opposite the first direction. Each link end 16a of the second set of link ends 16 has a second transverse opening 18. The first set of link ends 12 and the second set of link ends 16 being offset such that the first set of link ends interdigitate (i.e., are configured to interdigitate) with the second set of link ends of an adjacent module to provide aligned transverse openings (first transverse openings aligned with corresponding second transverse openings) for connecting adjacent modules with pivot rods 20.

The module 10 includes a plurality of ribs 30. Each rib 30a of the plurality of ribs 30 has a longitudinal axis, [symbol] . In some embodiments, the longitudinal axis is arranged along the direction of travel. The phrase “along the direction of travel,” as used herein, does not necessarily mean parallel with the direction of travel. For example, the ribs may form an angle to the direction of travel of between 0° (i.e., parallel) and 45°, inclusive. For example, in various embodiments, the longitudinal axis of each rib of the plurality of ribs forms an angle of within 45°, 30°, 20°, 10°, or 0° of parallel to the direction of travel. In some embodiments, the longitudinal axis of each rib is arranged along a direction transverse with respect to the direction of travel. For example, in various embodiments, the longitudinal axis of each rib of the plurality of ribs forms an angle of greater than 45°, 60°, 70°, or 80° of parallel to the direction of travel or the longitudinal axis may be at 90° to the direction of travel.

In some embodiments, one or more ribs of the plurality of ribs 30 is (are) spaced apart from adjacent ribs along a transverse direction, [symbol] . Rib spacing (i.e., the space between each rib) may be uniform or may vary. For example, a belt design might require smaller spacing between ribs at one or both the sides of a conveyor belt and, thus, larger spacing in the center of the belt. In some embodiments, one or more ribs are spaced apart along the direction of travel. In some embodiments, one or more ribs are aligned (i.e., aligned with each other) along the direction of travel. In some embodiments, one or more ribs of the plurality of ribs is spaced apart from adjacent ribs along the direction of travel.

A top surface 32 of each of the ribs 30a has a waveform profile. The term “waveform profile,” as used herein, refers to a surface configuration characterized by an undulating topography. Such a configuration may include, by way of non-limiting example, an oscillatory shape exhibiting periodic or semi-periodic fluctuations, an irregular shape defined by aperiodic or random variations in contour, or other such profiles exhibiting deviations from a planar or linear baseline. In more specific, non-limiting examples, the waveform profile may be sinusoidal shape, a triangular shape, a sawtooth shape, a square shape, or the like.

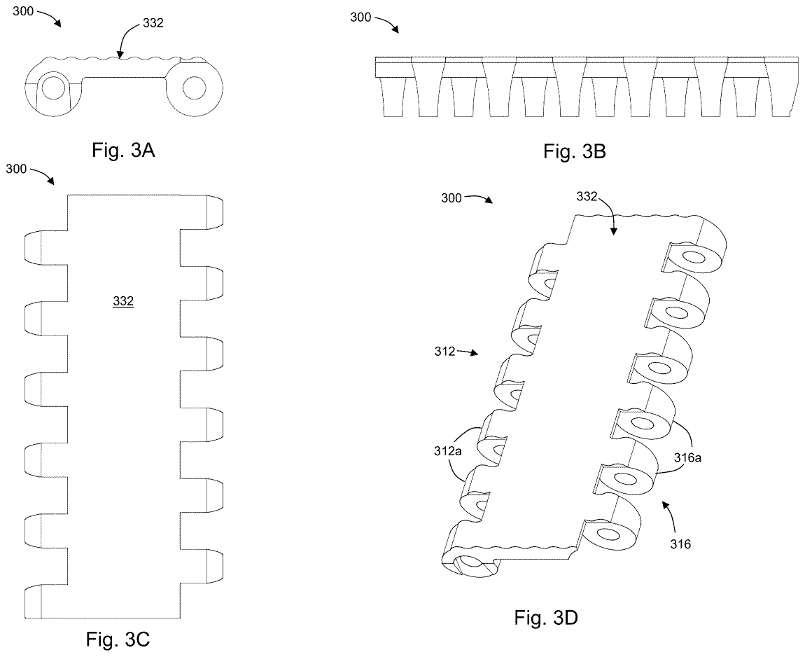

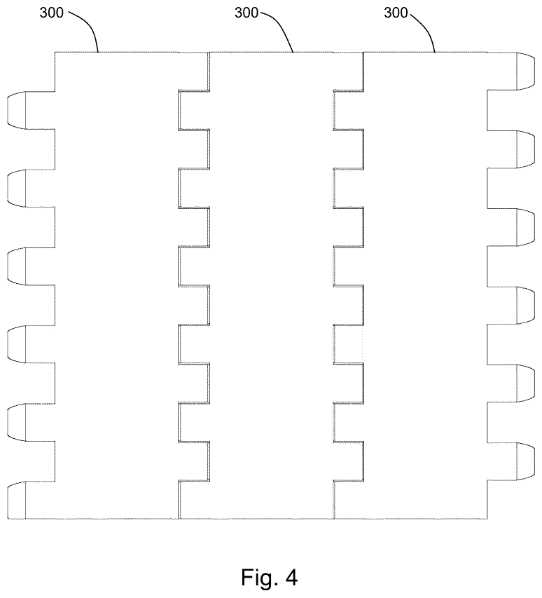

FIG. 2 depicts a conveyor belt section made up of two adjacent modules 10 similar to the modules shown in FIGS. 1A-1D. The adjacent modules are connected by a pivot rod 20 disposed through the transverse openings of the first set of link ends of a module and the second set of link ends of the adjacent module. Similarly, FIG. 4 depicts a belt section made up of three modules of the embodiment shown in FIGS. 3A-3D.

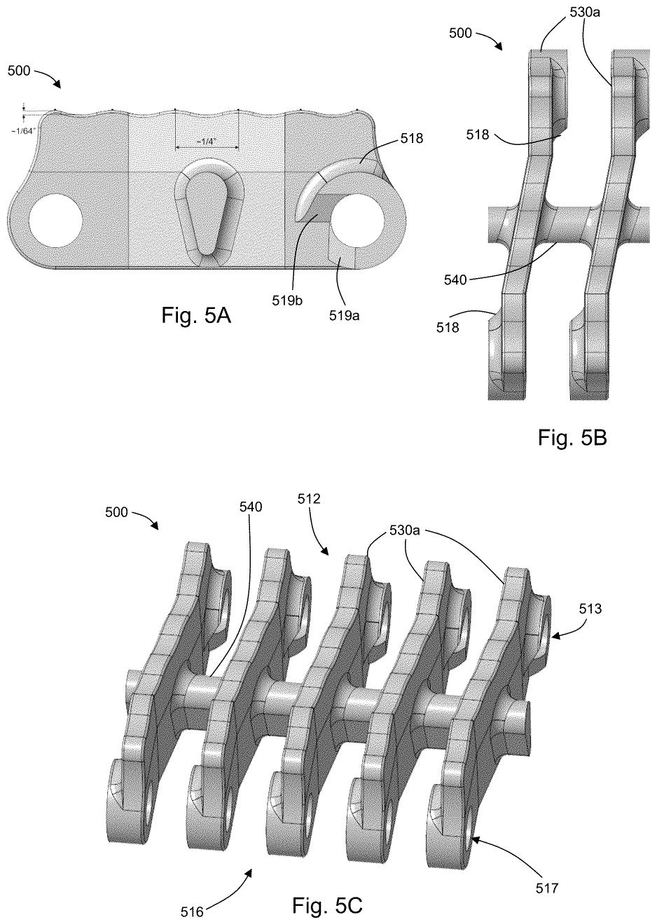

In some embodiments, a first end of each rib of the plurality of ribs is offset with a second end such that the ribs of the module are arranged to interdigitate with ribs of adjacent modules. For example, in the belt module 500 of FIGS. 5A-5C, the ribs 530 extend into each of the set of first link ends 512 and the set of second link ends 516. In can be seen that each rib is offset such that the link ends of adjacent belt modules are able to interdigitate (i.e., the first link ends of a belt module are able to interdigitate with the second link ends of an adjacent belt module). In some embodiments, adjacent ribs of the plurality of ribs are staggered such that a first subset of ribs aligns with each link end of the first set of link ends and a second subset of ribs aligns with each link end of the second set of link ends. For example, the module 10 of FIGS. 1A-1D shows where a first subset of ribs 30a align with the first set of link ends 12, and a second subset of ribs aligns with the second set of link ends 16.

The module may have a pitch of between 0.5″ to 3″, inclusive. In some embodiments, the pitch may be less than 0.5″. In some embodiments, the pitch may be more than 3″. The wavelength (i.e., the length of each repeat of a repeating pattern) of the waveform profile may be between 0.125″ to 3″, inclusive. The waveform profile has a wavelength-to-amplitude ratio of from 3:1 to 50:1, inclusive. Profiles having ratios within this range have been shown in testing to provide advantageous non-stick properties. In the example shown in FIG. 5A, the amplitude (from peak to trough) of the waveform profile is 1/64″ and the wavelength is ¼″; therefore, the wavelength-to-amplitude ratio is 16:1.

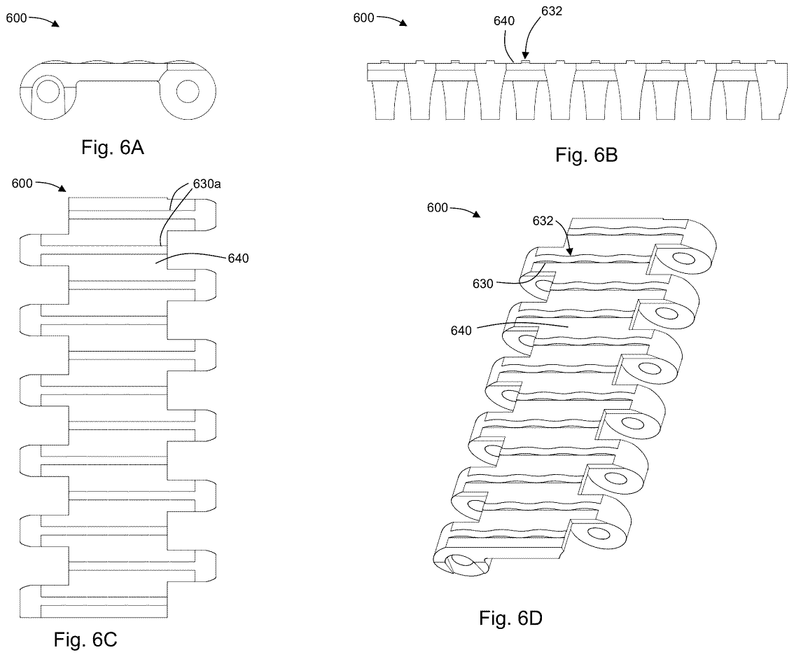

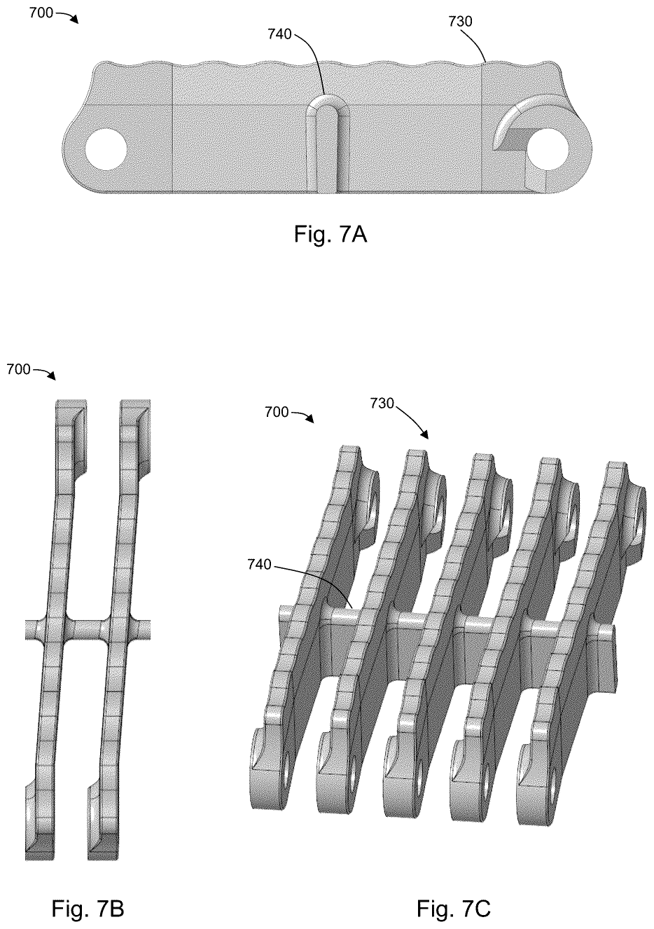

In some embodiments, such as that depicted in FIGS. 5A-5C, the belt module 500 may have a module body 540. Each rib 530a of the plurality of ribs may be attached to the module body 540. Similarly, the set of first link ends 514 and the set of second link ends 516 may extend from the module body 540. In some embodiments, the first set of link ends 514 and the second set of link ends 516 may be formed by the ribs 530. As such, the link ends may be integrated as part of the ribs. FIGS. 6A-6D depict an embodiment of a belt module 600 where each rib 630a extends from a module body 640 such that the top surface 632 of the ribs is above the module body 640. FIGS. 7A-7C show an embodiment of a module 700 wherein the plurality of ribs 730 extends from a module body 740.

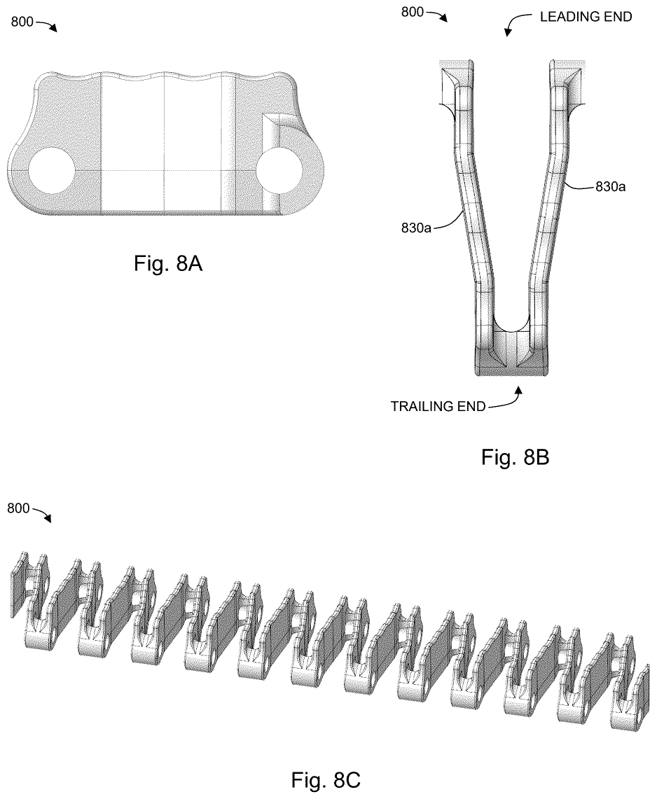

In other embodiments, the ribs of a module are not connected to each other by a module body. For example, in the embodiment 800 depicted in FIGS. 8A-8C, the ribs 830 are connected to each other (i.e., connected to an adjacent rib) at the link ends 814, 816. In other words, each rib is connected to an adjacent rib at an alternating one of the first end or the second end to form link ends.

In some embodiments, such as the module shown in FIGS. 8A-8C, each rib 830a of the plurality of ribs 830 extends from a leading end of the module to a trailing end of the module (see also, for example, ribs 530 of FIGS. 5A-5C). In other embodiments, one or more ribs of the plurality of ribs extends less than a distance from a leading end of the module to a trailing end of the module. For example, in the module 10 of FIGS. 1A-1D, each rib extends from a link end to a distance less than the width of the module.

The top surfaces 32 of the plurality of ribs 30 make up a conveying surface of the module. In some embodiments, such as the module 300 of FIGS. 3A-3D, the top surfaces of the plurality of ribs are contiguous and form a monolithic top surface 332.

In some embodiments, the transverse openings 513 of the first set of link ends 512 and the transverse openings 517 of the second set of link ends 516 are formed by hinge walls. In other words, the material making up the transverse openings has a thickness which is greater than a thickness of the rib. The increased-thickness hinge walls may extend entirely around the transverse openings (i.e., 360°) or may extend less than the entire circumference of the transverse openings. The increased thickness may be uniformly thick or may vary in thickness (see, for example, ramps 519a and 519b of FIG. 5A). In some embodiments, an interface of each hinge wall and the corresponding rib has a fillet 518. In this way, the modules (and resulting conveyor belt or chain) may be more easily cleaned.

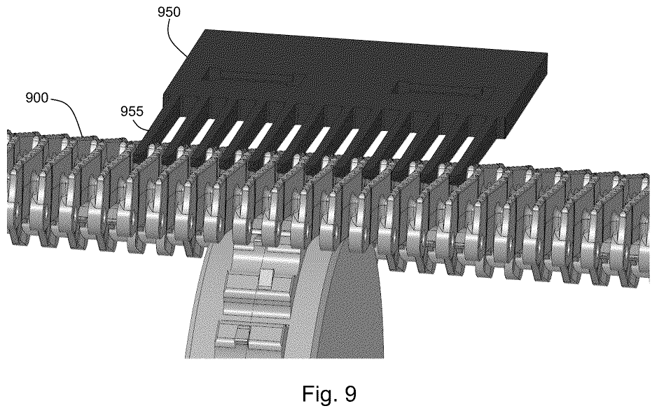

Some embodiments of the present disclosure may be used with a comb to remove material from the conveying surface. For example, FIG. 9 depicts a module 900 interfacing with a comb 950 which has tines 955 able to pass between ribs and lift material from the belt surface.

In another aspect, the present disclosure may be embodied as a conveyor belt or a conveyor chain. The conveyor belt or conveyor chain is made up of a plurality of modules according to any of the embodiments disclosed herein, each module of the plurality of modules is connected to adjacent modules using pivot rods (for example, disposed through the transverse openings of interdigitated link ends).

While the foregoing description primarily refers to “modular conveyor belts” and “belt modules” for illustrative purposes, it is to be understood that the scope of the present disclosure encompasses conveyor chains and modules for such chains as well, wherein the principles and mechanisms disclosed herein may be adapted to such systems without departing from the spirit of the invention. It is to be understood that in certain embodiments (such as, for example, in conveyor chain module embodiments), a set of link ends may include one or more link ends. For example, a first set of link ends may include a single link end. As used herein, the term “direction of travel” refers to a predetermined path along which a conveyor belt or conveyor chain (and the objects transported thereon) travels during operation.

Although the present disclosure has been described with respect to one or more particular embodiments, it will be understood that other embodiments of the present disclosure may be made without departing from the spirit and scope of the present disclosure.

1. A module for a modular conveyor belt or conveyor chain, comprising:
a first set of link ends extending in a first direction along a direction of travel, each link end of the first set of link ends having a transverse opening;
a second set of link ends extending in a second direction opposite the first direction, each link end of the first set of link ends having a transverse opening, and the first and second link ends being offset such that the first set of link ends are configured to interdigitate with the second set of link ends of an adjacent module to provide aligned transverse openings for connecting adjacent modules with pivot rods; and
a plurality of ribs, each rib having a longitudinal axis, wherein a top edge of each of the ribs has a waveform profile and a conveying surface is formed by the top edges of the plurality of ribs.

2. The module of claim 1, further comprising a module body and wherein the plurality of ribs is attached to the module body.

3. The module of claim 2, wherein the first set of link ends and the second set of link ends extend from the module body.

4. The module of claim 1, wherein the first set of link ends and the second set of link ends are formed by the ribs.

5. The module of claim 1, wherein each transverse opening of the first set of link ends and the second set of link ends is formed by a hinge wall which has a thickness greater than a thickness of the rib.

6. The module of claim 5, wherein an interface of each hinge wall and the corresponding rib has a fillet.

7. The module of claim 1, wherein each rib of the plurality of ribs extends from a leading end of the module to a trailing end of the module.

8. The module of claim 1, wherein one or more ribs of the plurality of ribs extends less than a distance from a leading end of the module to a trailing end of the module.

9. The module of claim 8, wherein one or more ribs are spaced apart along the direction of travel.

10. The module of claim 9, wherein one or more ribs are aligned along the direction of travel.

11. The module of claim 1, wherein adjacent ribs of the plurality of ribs are staggered such that a first subset of ribs aligns with each link end of the first set of link ends and a second subset of ribs aligns with each link end of the second set of link ends.

12. The module of claim 1, wherein a first end of each rib of the plurality of ribs is offset with a second end such that the ribs of the module are arranged to interdigitate with ribs of adjacent modules.

13. The module of claim 1, wherein each rib is connected to an adjacent rib at an alternating one of the first end or the second end to form a link end.

14. The module of claim 1, wherein the waveform profile has a sinusoidal shape, a triangular shape, or a square shape.

15. The module of claim 1, wherein the waveform profile has a wavelength of between 0.125″ to 3″, inclusive.

16. The module of claim 1, wherein the waveform profile has a wavelength-to-amplitude ratio of from 3-50:1, inclusive.

17. The module of claim 1, wherein the module has a pitch of between 0.5″ to 3″, inclusive.

18. The module of claim 1, wherein the longitudinal axis of each rib is arranged along the direction of travel, and wherein one or more ribs are spaced apart from adjacent ribs along a transverse direction.

19. The module of claim 18, wherein each rib of the plurality of ribs is within 45°, 30°, 20°, or 10°of parallel to the direction of travel.

20. The module of claim 1, wherein the longitudinal axis of each rib is arranged along a direction transverse with respect to the direction of travel, and wherein one or more ribs are spaced apart from adjacent ribs along the direction of travel.

21. A conveyor belt comprising a module according to claim 1.

22. A conveyor chain comprising a module according to claim 1.
